(19) United States
(12) Patent Application Publication
(10) Pub. No.: US 2012/0085321 A1
(43) Pub. Date: Apr. 12, 2012

(54) FUEL DISTRIBUTION PIPE FOR A MOTOR VEHICLE AND METHOD FOR ARRANGING A FUEL DISTRIBUTION PIPE

(75) Inventors: MARKO LINDNER, Ingolstadt (DE); FRANZ BÄUMEL, Kipfenberg (DE); WERNER TREBUS, Manching (DE)

(73) Assignee: Audi AG, Ingolstadt (DE)

(21) Appl. No.: 13/082,900

(22) Filed: Apr. 8, 2011

(30) Foreign Application Priority Data
Apr. 10, 2010 (DE) 10 2010 014 498.3

(51) Int. Cl. F02M 55/02; B23P 17/04

(52) U.S. Cl. 123/469; 29/890.09

(57) ABSTRACT

A fuel distribution pipe for a motor vehicle includes a tubular body having an end face, and a closure part which is arranged on the end face for sealing the tubular body against fuel leakage. The closure part is constructed as a retaining member for securing the fuel distribution pipe on a component of the motor vehicle.

### CROSS-REFERENCES TO RELATED APPLICATIONS

This application claims the priority of German Patent Application, Serial No. 10 2010 014 498.3, filed Apr. 10, 2010, pursuant to 35 U.S.C. 119(a)-(d), the content of which is incorporated herein by reference in its entirety as if fully set forth herein.

### BACKGROUND OF THE INVENTION

The present invention relates to a fuel distribution pipe for installation in a motor vehicle.

The following discussion of related art is provided to assist the reader in understanding the advantages of the invention, and is not to be construed as an admission that this related art is prior art to this invention.

Retaining members are typically used for installing a fuel distribution pipe on a component of a motor vehicle. These retaining members typically require installation space, in particular in areas intended to also accommodate other components of the motor vehicle.

It would therefore be desirable and advantageous to provide an improved fuel distribution pipe which obviates prior art shortcomings and allows installation to alleviate the installation space situation.

### SUMMARY OF THE INVENTION

According to one aspect of the present invention, a fuel distribution pipe for a motor vehicle includes a tubular body having an end face, and a closure part arranged on the end face for sealing the tubular body against fuel leakage, the closure part being constructed as a retaining member for securing the fuel distribution pipe on a component of the motor vehicle.

The present invention resolves prior art shortcomings by providing a closure part which is formed as a retaining member configured for mounting the fuel distribution pipe on a component. By assigning two functions to the closure part, namely, on one hand, the function of sealing the tubular body against fuel leakage and, on the other hand, the function of the retaining member, the fuel distribution pipe requires little installation space and can be easily and cost-effectively installed because there is no need to attach retaining members on the tubular body after the tubular body is sealed.

By arranging the retaining member on the end face of the tubular body, there remains still installation space available in the radial direction around the tubular body for installation of other components of the motor vehicle. The fuel distribution pipe can be manufactured quickly and cost-effectively from only a few parts. In addition, comparatively few attachment zones need to be provided for joining the individual components together.

According to another advantageous feature of the present invention, the closure part may include at least one receptacle for a fastening element. In this way, a particularly resilient attachment of the fuel distribution pipe on the component of the motor vehicle can be achieved.

According to another advantageous feature of the present invention, the receptacle can be particularly easily produced if it is formed unthreaded. Holding forces can be applied by inserting the fastening element into a thread provided on the component.

According to another advantageous feature of the present invention, the closure part may have a recess for receiving, at least in part, an end region of the fastening element. When being completely received in the recess, the end region of the fastening element does not significantly interfere.

According to another advantageous feature of the present invention, the closure part can have a length which is greater than an outside diameter of the tubular body. The closure part can thereby attain a particularly high stability. In particular, when the closure part has at least one receptacle for a fastening element, the receptacle can provide excellent guidance for the fastening element.

According to another advantageous feature of the present invention, the closure part can have a connection fitting encompassing an outside periphery of the tubular body. As a result, the tubular body can be particularly effectively sealed by the closure part.

The closure part may have a smooth contact surface for the tubular body to facilitate connection to the tubular body. As an alternative or in addition, the closure part may have a smooth contact surface for the component of the motor vehicle, thereby providing a particularly good support in the additional component via the second contact surface.

According to another advantageous feature of the present invention, the closure part may be made of steel able to readily withstand a fuel pressure in the tubular body. Advantageously, closure part may be made from a forged steel and configured as a forged part. In contrast to a closure part that has been produced by joining components through brazing or welding or by machining such as milling, but also unlike a closure part in the form of a cast part, a forged part can be produced in a particularly simple and cost-effective manner while still being sufficiently precise.

According to another advantageous feature of the present invention, the closure part can be attached to the end face of the tubular body by a material joint. Examples of a material joint include brazing or welding. This type of joint provides a particularly good seal between the tubular body and the closure part formed as a retaining member.

According to another aspect of the present invention, a method of installing a fuel distribution pipe on a component of a motor vehicle includes the steps of arranging a closure part constructed as a retaining member on an end face of a tubular body for sealing the tubular body against fuel leakage, and securing the fuel distribution pipe on the component of the motor vehicle with the closure part. Thus, the closure part can be used not only to seal the tubular body but also to secure the fuel distribution pipe on the component of the motor vehicle.

### BRIEF DESCRIPTION OF THE DRAWING

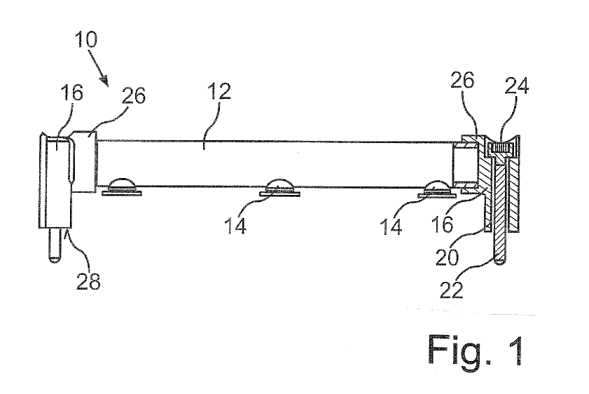

Other features and advantages of the present invention will be more readily apparent upon reading the following description of currently preferred exemplified embodiments of the invention with reference to the accompanying drawing, in which the sole FIG. 1 shows in a partial cross-sectional view of a fuel distribution pipe according to the present invention for installation in a motor vehicle.

### DETAILED DESCRIPTION OF PREFERRED EMBODIMENTS

The depicted embodiment is to be understood as illustrative of the invention and not as limiting in any way. Details which are not necessary for an understanding of the present invention or which render other details difficult to perceive may have been omitted.

Turning now to FIG. 1, there is shown a partial cross-sectional view of a fuel distribution pipe according to the present invention, generally designated by reference numeral 10 for installation in a motor vehicle. The fuel distribution pipe 10 includes a tubular body 12 which has openings disposed in a bottom side, when installed. So-called cups 14, which are used to secure (not shown) injectors, are inserted into these bottom openings. Fuel, which is present in the tubular body 12 at a pressure of up to 150 bar, is introduced via the injectors into the respective combustion chamber of a cylinder of the vehicle engine.

The tubular body 12 has closure parts 16 arranged on both end faces, with one of the closure parts 16 illustrated in cross-section. The closure parts 16 are provided to seal the tubular body 12 against fuel leakage. At the same time, the two closure parts 16 are constructed as retaining members with which the fuel distribution pipe 10 can be attached to an (not shown) cylinder head of the engine. As an alternative, the fuel distribution pipe 10 may be secured, for example by a screw connection, to another component other than the cylinder head of the engine.

The closure parts 16 have respective through holes 20 for receiving screw fasteners 22. The through-holes 20 do not have threads, and the screw fasteners 22 engage corresponding (not shown) threaded bores for attaching the fuel distribution pipe 10 on the cylinder head. A head 24 of the screw fastener 22 is countersunk in a recess of the closure part 16. The through hole 20 for the screw fastener 22 has a length which is greater than an outside diameter of the tubular body 12.

The closure part 16 has a connection fitting 26 in surrounding relationship to the outside periphery of the tubular body 12. The closure part 16 is refinished in a contact region of the closure part 16 with the tubular body 12 to provide a smooth contact surface for the tubular body 12. A bottom side 28 of the closure part 16 is also refinished so that the bottom side 28 can be brought into full contact with the cylinder head in the region of the threaded bores.

The closure part 16 in the present example is formed as a forged part manufactured from forged steel and connected with the tubular body 12 through brazing or welding.

While the invention has been illustrated and described in connection with currently preferred embodiments shown and described in detail, it is not intended to be limited to the details shown since various modifications and structural changes may be made without departing in any way from the spirit and scope of the present invention. The embodiments were chosen and described in order to explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

What is claimed is:

1. A fuel distribution pipe for a motor vehicle, comprising:
a tubular body having an end face, and
a closure part arranged on the end face for sealing the tubular body against fuel leakage, said closure part being constructed as a retaining member for securing the fuel distribution pipe on a component of the motor vehicle.

2. The fuel distribution pipe of claim 1, wherein the closure part has at least one receptacle configured to receive fastening element.

3. The fuel distribution pipe of claim 2, wherein the receptacle is formed in the absence of a thread.

4. The fuel distribution pipe of claim 2, wherein the closure part has a recess for receiving, at least in part, an end region of the fastening element.

5. The fuel distribution pipe of claim 1, wherein the closure part has a length which is greater than an outside diameter of the tubular body.

6. The fuel distribution pipe of claim 1, wherein the closure part comprises a connection fitting encompassing an outside periphery of the tubular body.

7. The fuel distribution pipe of claim 1, wherein the closure part has at least one smooth contact surface for contacting the tubular body or the additional component, or both.

8. The fuel distribution pipe of claim 1, wherein the closure part is made from steel.

9. The fuel distribution pipe of claim 8, wherein the closure part is formed as a forged part.

10. The fuel distribution pipe of claim 1, wherein the closure part is secured to the end face of the tubular body by a material joint.

11. A method of installing a fuel distribution pipe on a component of a motor vehicle, comprising the steps of:
arranging a closure part constructed as a retaining member on an end face of a tubular body for sealing the tubular body against fuel leakage, and
securing the fuel distribution pipe on the component of the motor vehicle with the closure part.
